(19) United States
(12) Patent Application Publication
(10) Pub. No.: US 2009/0071483 A1
(43) Pub. Date: Mar. 19, 2009

(54) MASK HAVING HOLDING OBJECT

(76) Inventor: Se Hwa Son, Daejeon (KR)

Correspondence Address: HYUN JONG PARK;Park & Associates IP Law LLC, 265 Bic Drive, Suite 106, Milford, CT, 06461, US

(21) Appl. No.: 12/279,492

(22) PCT Filed: Feb. 7, 2007
(86) PCT No.: PCT/KR2007/000669

§ 371 Date: Aug. 14, 2008

(30) Foreign Application Priority Data
Feb. 14, 2006 (KR) 10-2006-0014348

(51) Int. Cl. A62B 18/08

(52) U.S. Cl. 128/206.13

(57) ABSTRACT

Disclosed is a mask in that a housing space is formed through a three dimensional type cover and a fixing supporter is inserted into an edge of the three dimensional type cover in order to prevent the mask from being easily polluted by adhering closely to a nose and mouth of wearer, so that the outward form of the three dimensional type cover can be maintained even though a comparatively small power such as a wind or a physical contact is applied thereto. The mask having a fixing supporter includes a body having a penetration portion of a predetermined size at the center thereof in order to insert a nose and a mouth of the wearer therein, a three dimensional type cover coupled to the body and separated from the penetration portion at a predetermined distance and having an opening portion for being indirectly ventilated to outside formed at the lower portion thereof in order that the nose and mouth of the wearer inserted into the penetration portion are wrapped up, an earring for wearing the mask on the ear coupled to both end portions of the body, and a fixing supporter inserted along a sewing portion located at the girth of the three dimensional type cover in order that the nose and mouth of the wearer are not adhered closely to the inside of the three dimensional type cover.

### REFERENCE TO RELATED APPLICATIONS

This is a continuation of pending International Patent Application PCT/KR2007/000669 filed on Feb. 7, 2007, which designates the United States and claims priority of Korean Patent Application No. 10-2006-0014348 filed on Feb. 14, 2006.

### FIELD OF THE INVENTION

The present invention relates to a mask in that a housing space is formed through a three dimensional type cover and a fixing supporter is inserted into an edge of the three dimensional type cover in order to prevent the mask from being easily polluted by adhering closely to a nose and mouth of wearer, so that the outward form of the three dimensional type cover can be maintained even though a comparatively small power such as a wind or a physical contact is applied thereto, more particularly, to a mask having a fixing supporter including a body having a penetration portion of a predetermined size at the center thereof in order to insert a nose and a mouth of the wearer therein, a three dimensional type cover coupled to the body and separated from the penetration portion at a predetermined distance and having an opening portion for being indirectly ventilated to outside formed at the lower portion thereof in order that the nose and mouth of the wearer inserted into the penetration portion are wrapped up, an earring for wearing the mask on the ear coupled to both end portions of the body, and a fixing supporter inserted along a sewing portion located at the girth of the three dimensional type cover in order that the nose and mouth of the wearer are not adhered closely to the inside of the three dimensional type cover.

### BACKGROUND OF THE INVENTION

Generally, a mask mainly divides into a winter mask and a mask for dust or sandy dust prevention according to the usage thereof.

The mask includes a body having a penetrated central portion for inserting the nose and mouth therein and breathing therethrough and the front cover attached to the front portion of the body, so that the wearer can breathe smoothly through a ventilating opening located at the nose and mouth thereof.

However, since the nose and mouth are protruded outside in general, it is inconvenient for wearing. Also, because the nose and mouth are adhered closely to the mask, it is inconvenient for breathing.

In order to solve the problem, a mask including a plurality of folding portion sewed along a sewing portion at the side thereof to be protruded toward the front thereof and an opening portion for being indirectly ventilated to outside formed at the lower portion thereof in order that the nose and mouth of the wearer inserted into the penetration portion are wrapped up is provided. Accordingly, a space is formed between the nose and mouth and the mask for covering them, thereby solving the inconvenience in breathing and wearing.

However, in case of the improved mask, since cosmetic materials such as a lipstick or a foundation and so on applied to the girth of the nose and mouth of women are contacted with the mask where a comparatively small power such as a wind or a physical contact is applied thereto, it is inconvenient for using.

Also, in case of wearing the glasses in winter, an opened space is generated by the ridge of the nose during wearing thereof, so that a steam can be generated on the glasses.

Accordingly, it has demanded a mask in that the outward form of the three dimensional type cover can be maintained even though the comparatively small power is applied thereto and the steam cannot be generated on the glasses in case of wearing the glasses in winter.

### SUMMARY OF THE INVENTION

It is, therefore, an object of the present invention provides a mask in that a housing space is formed through a three dimensional type cover and a fixing supporter is inserted into an edge of the three dimensional type cover in order to prevent the mask from being easily polluted by adhering closely to a nose and mouth of wearer, so that the outward form of the three dimensional type cover can be maintained even though a comparatively small power such as a wind or a physical contact is applied thereto.

To accomplish the object, the present invention provides a mask having a fixing supporter comprising: a body 10 having a penetration portion 11 of a predetermined size at the center thereof in order to insert a nose and a mouth of wearer therein; a three dimensional type cover 20 coupled to the body 10 and separated from the penetration portion 11 at a predetermined distance and having an opening portion 22 for being indirectly ventilated to outside formed at a lower portion thereof in order that the nose and mouth of the wearer inserted into the penetration portion are wrapped up; an earring 30 for wearing the mask 100 on the ear coupled to both end portions of the body 10; and a fixing supporter 40 inserted along a sewing portion located at the girth of the three dimensional type cover in order that the nose and mouth of the wearer are not adhered closely to an inside of the three dimensional type cover.

Preferably, the fixing supporter 40 is in the form of “U” shape in order that it corresponds to a lower end portion and a side of the three dimensional type cover 20.

Preferably, the fixing supporter 40 inserted into an upper end portion of the body 10 is in the form of “-” shape in order that it corresponds and adheres closely to an ridge of the nose.

Preferably, the three dimensional type cover 20 further comprises a plurality of folding portion 21 sewed along a sewing portion at a side thereof to be protruded toward the front thereof.

Preferably, the fixing supporter 40 comprises a core 41 made of nonferrous metals and a silicon 42 coated on the core 41.

Preferably, the fixing supporter 40 comprises a circular core 41 made of nonferrous metals and a silicon 42 of a bar shape having a contacting wing coated on the core 41 in order to increase the contacting area.

As described above, according to the mask having a fixing supporter, the housing space is formed through the three dimensional type cover and the fixing supporter is inserted into the edge of the three dimensional type cover in order to prevent the mask from being easily polluted by adhering closely to the nose and mouth of wearer, so that the outward form of the three dimensional type cover can be maintained even though the comparatively small power such as the wind or the physical contact is applied thereto.

Accordingly, although cosmetic materials such as a lipstick or a foundation and so on applied to the girth of the nose and mouth of women are contacted with the mask where the comparatively small power such as a wind or the physical contact is applied thereto, it can prevent the mask from being easily polluted.

Moreover, in case of wearing the glasses in winter, the opened space is not generated by the ridge of the nose during wearing thereof, whereby the steam cannot be generated on the glasses.

### BRIEF DESCRIPTION OF THE DRAWINGS

The above as well as the other objects, features and advantages of the present invention will be more apparent from the following detailed description taken in conjunction with the accompanying drawings, in which:

FIG. 1 is a first perspective view illustrating a mask having a fixing supporter according to the present invention;

FIG. 2 is a second perspective view illustrating a mask having a fixing supporter according to the present invention;

FIG. 3 is an exploded perspective view of FIG. 2;

FIG. 4 is a rear view of FIG. 2;

FIG. 5 is a perspective view illustrating a fixing supporter according to a first embodiment of the present invention extracted from a body and a three dimensional type cover of FIG. 2;

FIG. 6 is a perspective view illustrating a fixing supporter according to a second embodiment of the present invention extracted from a body and a three dimensional type cover of FIG. 2; and

FIG. 7 is a perspective view illustrating a using condition of a mask having a fixing supporter according to the present invention.

### DETAILED DESCRIPTION OF THE INVENTION

A preferred embodiment of the invention will be described in detail below with reference to the accompanying drawings.

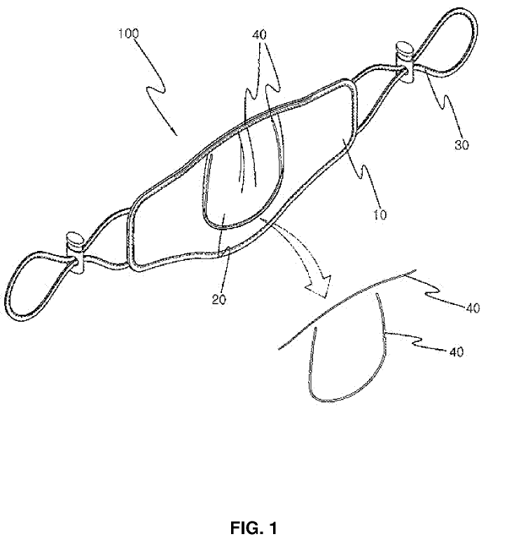

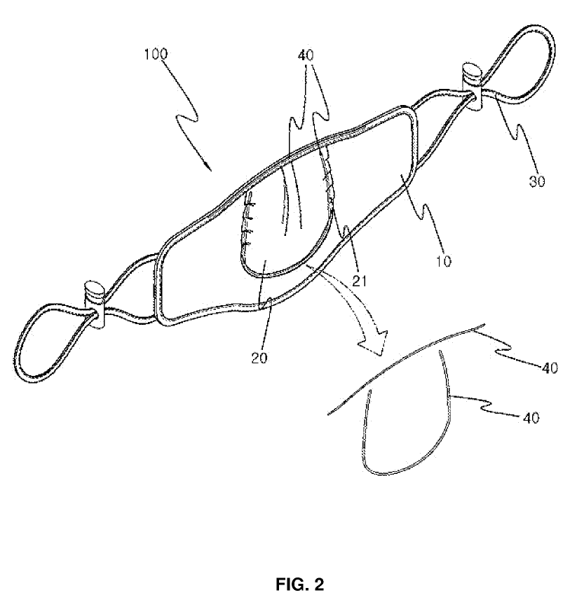

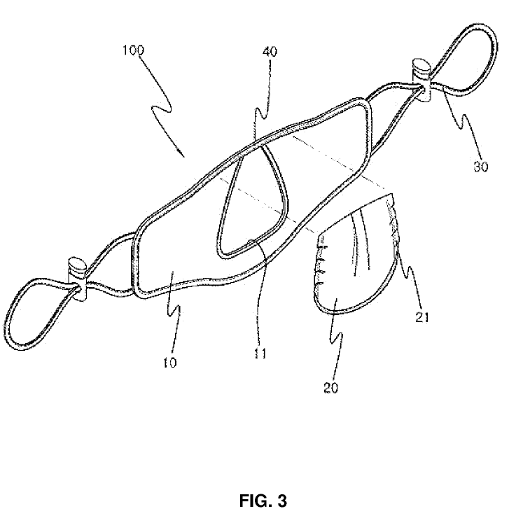

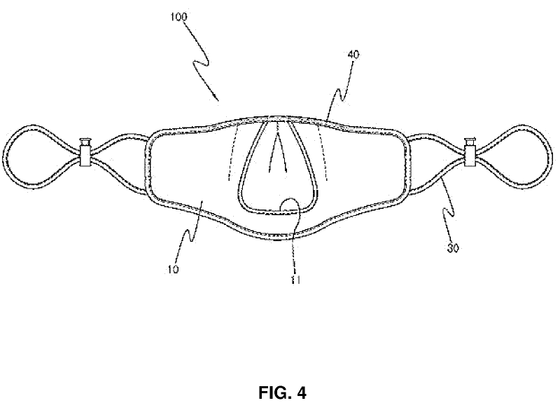

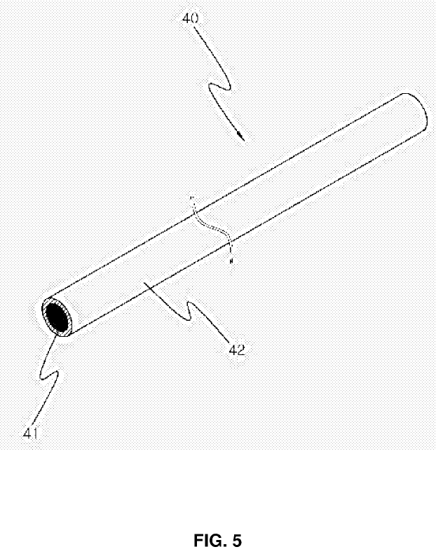

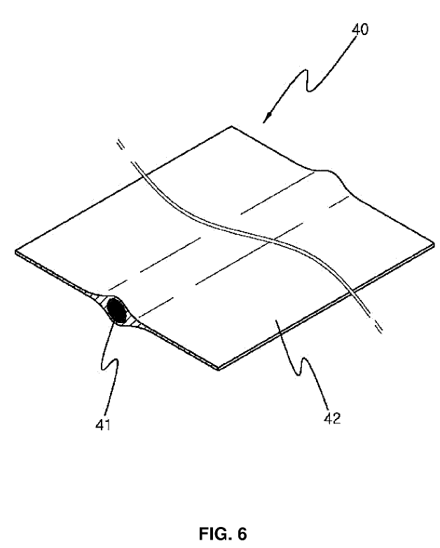

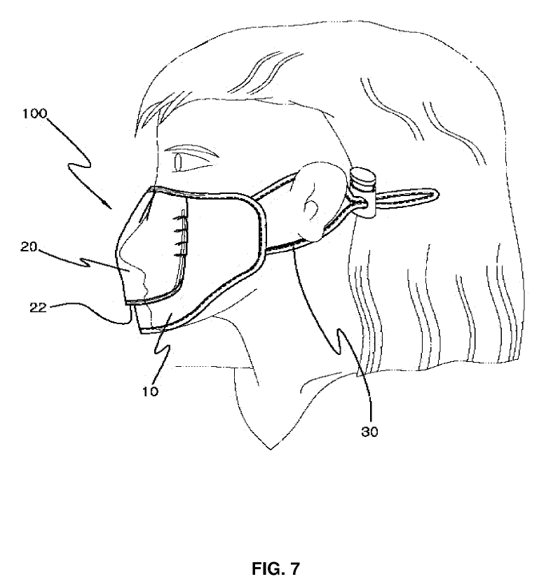

FIG. 1 is a first perspective view illustrating a mask having a fixing supporter according to the present invention, FIG. 2 is a second perspective view illustrating a mask having a fixing supporter according to the present invention, FIG. 3 is an exploded perspective view of FIG. 2, FIG. 4 is a rear view of FIG. 2, FIG. 5 is a perspective view illustrating a fixing supporter according to a first embodiment of the present invention extracted from a body and a three dimensional type cover of FIG. 2, FIG. 6 is a perspective view illustrating a fixing supporter according to a second embodiment of the present invention extracted from a body and a three dimensional type cover of FIG. 2, and FIG. 7 is a perspective view illustrating a using condition of a mask having a fixing supporter according to the present invention.

As shown in FIG. 1 through FIG. 7, the present invention relates to a mask having a fixing supporter in that a housing space is formed through a three dimensional type cover 20 and the fixing supporter 40 is inserted into an edge of the three dimensional type cover 20 in order to prevent the mask 100 from being easily polluted by adhering closely to a nose and mouth of wearer, so that the outward form of the three dimensional type cover 20 can be maintained even though a comparatively small power such as a wind or a physical contact is applied thereto.

The mask 100 according to the present invention includes a body 10 having a penetration portion 11 of a predetermined size at the center thereof in order to insert the nose and mouth of the wearer therein, the three dimensional type cover 20 having a plurality of folding portion 21 sewed along a sewing portion at the side thereof to be protruded toward the front thereof and an opening portion 22 for being indirectly ventilated to outside formed at the lower portion thereof in order that the nose and mouth of the wearer inserted into the penetration portion 11 are wrapped up, an earring 30 for wearing the mask 100 on the ear coupled to both end portions of the body 10.

Here, the body 10 covers the lower portion of the wearer's face, so that it can protect against the cold or the dust and so on. Preferably, the material of the body 10 may be a micro fiber in order to protect against the dust and so forth.

Also, since the body is directly contacted with the skin of the wearer, it is preferred that the material thereof is soft and airy.

Moreover, the penetration portion 11 is formed at the center of the body 10 in order that the nose and mouth of the wearer are inserted therein to be breathed. Here, the penetration portion 11 is gradually widened in width toward the lower portion from the upper portion thereof so as to be suited to the location of the mouth and breathe easily.

In the meantime, the earring 30 for wearing the mask 100 on the ear is connected to both end portions of the body 10.

Furthermore, the three dimensional type cover 20 is seamed up the front surface of the penetration portion 11 of the body 10. The three dimensional type cover 20 includes the plurality of folding portion 21 formed along the sewing portion thereof in order that the nose and mouth of the wearer are taken therein without adhering the nose and mouth closely thereto.

The plurality of folding portion 21 of the three dimensional type cover 20 is sewed along the girth adjacent to the penetration portion 11, so that the three dimensional type cover 20 is protruded in three dimension as seen from the side thereof.

Here, the plurality of folding portion 21 of the three dimensional type cover 20 is sewed while being folded in the form of “Z” shape along the width direction thereof.

Accordingly, the nose and mouth of the wearer inserted into the penetration portion 11 are taken to the inside of the three dimensional type cover 20 at regular intervals.

Since the nose and mouth of the wearer inserted into the penetration portion 11 are taken to the inside of the three dimensional type cover 20 at regular intervals, it can prevent the mask 100 from being contaminated and getting wet on account of the moisture discharged during breathing.

Also, the opening portion 22 is formed at the lower portion of the three dimensional type cover 20 in order to be indirectly ventilated to outside.

In the meantime, the fixing supporter 40 is inserted into the three dimensional type cover 20, so that the housing space is formed, thereby the nose and mouth of the wearer are not adhered closely to the inside of the three dimensional type cover 20.

The fixing supporter 40 is inserted along the sewing portion located at the girth of the three dimensional type cover 20. Here, the fixing supporter 40 is in the form of “U” shape in order that it corresponds to the lower end portion and side of the three dimensional type cover 20.

Accordingly, the housing space formed by three dimensional type cover 20 is not transformed even though the external force is applied, so that the outward form of the three dimensional type cover 20 can be maintained in an original state.

That is, since the edge of the three dimensional type cover 20 is stably supported by the fixing supporter 40, in case of the front of the three dimensional type cover 20 made of a fiber material, the outward form thereof is returned against the comparatively small power.

Accordingly, even though the comparatively small power is applied to the three dimensional type cover 20, since the outward form thereof can be maintained, it can prevent the external material such as the oiliness generated from the cosmetics or skin from being adhered to the mask 100 by contacting the mouth and nose with it owing to the wind or the physical contact.

The fixing supporter 40 is inserted into the upper end portion of the body 10 besides the three dimensional type cover 20.

The fixing supporter 40 inserted into the upper end portion of the body 10 is in the form of “-” shape in order that it corresponds and adheres closely to the ridge of the nose.

Accordingly, in case of wearing the glasses in winter, it can prevent the opened space generated by the ridge or line of the nose during wearing thereof, so that it can prevent a steam generated on the glasses.

That is, in order to minimize the opened space generated at the both sides of the upper end portion of the mask 100, the fixing supporter 40 can be bent correspondingly to the shape of the ridge or line of the nose.

As shown in FIG. 5, the fixing supporter 40 as the first embodiment of the present invention includes a core 41 made of nonferrous metals and a silicon 42 coated on the core 41.

Since the core 41 is made of nonferrous metals, it can prevent the oxidized core 41 from being absorbed into a human body. Here, it is preferred that the material of the fixing supporter 40 may be an aluminum alloy among nonferrous metals.

The silicon 42 serves to prevent the human body from being damaged owing to the core 41 of a pole shape. Also, the silicon 42 serves to prevent the core from being twisted or destroyed on account of a fatigue strength thereof.

In the meantime, as shown in FIG. 6, the fixing supporter 40 as the second embodiment of the present invention includes a circular core 41 made of nonferrous metals and a silicon 42 of a bar shape having a contacting wing coated on the core 41 in order to increase the contacting area.

Here, selectively, the fixing supporter 40 as the second embodiment of the present invention is laid on or vertically inserted.

### INDUSTRIAL APPLICABILITY

The present invention relates to a mask in that a housing space is formed through a three dimensional type cover and a fixing supporter is inserted into an edge of the three dimensional type cover in order to prevent the mask from being easily polluted by adhering closely to a nose and mouth of wearer, so that the outward form of the three dimensional type cover can be maintained even though a comparatively small power such as a wind or a physical contact is applied thereto.

While the present invention has been described with reference to the particular illustrative embodiments, it is not to be restricted by the embodiments but only by the appended claims. It is to be appreciated that those skilled in the art can change or modify the embodiments without departing from the scope and spirit of the present invention.

What is claimed is:

1. A mask having a fixing supporter comprising:
a body 10 having a penetration portion 11 of a predetermined size at the center thereof in order to insert a nose and a mouth of wearer therein;
a three dimensional type cover 20 coupled to the body 10 and separated from the penetration portion 11 at a predetermined distance and having an opening portion 22 for being indirectly ventilated to outside formed at a lower portion thereof in order that the nose and mouth of the wearer inserted into the penetration portion are wrapped up;
an earring 30 for wearing the mask 100 on an ear of the wearer coupled to both end portions of the body 10; and
a fixing supporter 40 inserted along a sewing portion located at the girth of the three dimensional type cover 20 in order that the nose and mouth of the wearer are not adhered closely to an inside of the three dimensional type cover.

2. A mask having a fixing supporter claimed in claim 1, wherein the fixing supporter 40 is in the form of “U” shape in order that it corresponds to a lower end portion and a side of the three dimensional type cover 20.

3. A mask having a fixing supporter claimed in claim 1, wherein the fixing supporter 40 inserted into an upper end portion of the body 10 is in the form of “-” shape in order that it corresponds and adheres closely to an ridge of the nose.

4. A mask having a fixing supporter claimed in claim 1, wherein the three dimensional type cover 20 further comprises a plurality of folding portion 21 sewed along a sewing portion at a side thereof to be protruded toward the front thereof.

5. A mask having a fixing supporter claimed in claim 1, wherein the fixing supporter 40 comprises a core 41 made of nonferrous metals and a silicon 42 coated on the core 41.

6. A mask having a fixing supporter claimed in claim 1, wherein the fixing supporter 40 comprises a circular core 41 made of nonferrous metals and a silicon 42 of a bar shape having a contacting wing coated on the core 41 in order to increase a contacting area thereof.

7. A mask having a fixing supporter claimed in claim 1, wherein the penetration portion 11 is gradually widened in width toward a lower portion from an upper portion thereof so as to insert the nose and mouth of the wearer therein.
